(19) United States
(12) Patent Application Publication
(10) Pub. No.: US 2024/0313371 A1
(43) Pub. Date: Sep. 19, 2024

(54) METHOD FOR MANUFACTURING CORROSION-PREVENTING LAYER, AND CYLINDRICAL SECONDARY BATTERY

(71) Applicant: LG ENERGY SOLUTION, LTD., Seoul (KR)

(72) Inventors: Jimin JUNG, Daejeon (KR); Je Jun LEE, Daejeon (KR); Hak Kyun KIM, Daejeon (KR)

(73) Assignee: LG ENERGY SOLUTION, LTD., Seoul (KR)

(21) Appl. No.: 18/267,027

(22) PCT Filed: Mar. 3, 2022
(86) PCT No.: PCT/KR2022/003053

§ 371 Date: Jun. 13, 2023

(30) Foreign Application Priority Data
Mar. 8, 2021 (KR) 10-2021-0030319

(51) Int. Cl. H01M 50/571; H01M 10/04; H01M 50/107; H01M 50/119; H01M 50/124

(52) U.S. Cl. CPC H01M 50/571; H01M 10/0422; H01M 50/107; H01M 50/119; H01M 50/124

(57) ABSTRACT

A manufacturing method for providing a corrosion prevention layer on a cylindrical secondary battery including a jelly-roll type electrode assembly having a structure in which a first electrode, a second electrode, and a separator interposed therebetween are wound in one direction based on a winding axis, a battery can accommodating the electrode assembly and the battery can including a metal plated layer, and a connection lead plate joining the battery can and the electrode assembly, of which the method includes applying a resin to a portion where the metal plated layer is welded to the connection lead plate, and forming the corrosion prevention layer by curing the resin by ultraviolet rays. The resin includes one or more liquid materials. The one or more liquid materials are ultraviolet curable. The one or more liquid materials have a viscosity of 1 cP to 5000 cP.

### TECHNICAL FIELD

This application claims priority to and the benefit of Korean Patent Application No. 10-2021-0030319 filed in the Korean Intellectual Property Office on Mar. 8, 2021, the entire contents of which are incorporated herein by reference.

The present invention relates to a manufacturing method of a corrosion prevention layer and a cylindrical secondary battery, and more particularly, to a manufacturing method of a corrosion prevention layer and a cylindrical secondary battery capable of preventing corrosion of a battery can.

### BACKGROUND ART

A conventional cylindrical secondary battery has a structure in which a tab linking a jelly-roll electrode assembly and an external terminal is welded and connected to a foil of the jelly-roll an electrode assembly. The cylindrical secondary battery having such a structure has a problem in that a current path is limited and resistance of the jelly-roll electrode assembly itself is high.

In order to improve this, there is an attempt to decrease the resistance in order to increase the number of tabs, but there is a limit to sufficiently ensure the current path or decrease the resistance to a desired level. In order to resolve such a limit, there is an attempt to decrease resistance in a welding process applied to a battery can.

However, an exterior of the battery can of the cylindrical secondary battery is generally constituted by a metal plated layer, and a welding process of an electrode is a laser welding and a bottom welding can be performed on the exterior of the battery can made of the metal plated layer, and as a result, the metal plated layer constituting the exterior of the battery can be damaged.

When the metal plated layer is damaged as such, a surface is exposed to the air, and as a result, the battery can may be corroded.

In order to solve the above problem, a method for applying a corrosion inhibition liquid to the metal plated layer, and then cleaning the metal plated layer is adopted. However, since a corrosion inhibition liquid component can be easily removed even by the method, the battery can may be easily corroded.

Accordingly, another material or method for efficiently preventing corrosion of the battery can is required by comprehensively solving the problem.

### DISCLOSURE

### Technical Problem

In order to solve the problem, one object of the present invention is to provide a manufacturing method of a corrosion prevention layer and a cylindrical secondary battery.

However, a problem to be solved by the present invention is not limited to the above-described problem, and other problems not mentioned in the present specification will be able to be clearly appreciated by those skilled in the art from a description of the invention to be described below.

### Technical Solution

In order to achieve the object, the present invention provides a manufacturing method of a corrosion prevention layer and a second battery according to the following aspect.

According to one aspect of the present invention, provided is a manufacturing method of a corrosion prevention layer of a cylindrical secondary battery including a jelly-roll type electrode assembly having a structure in which a first electrode, a second electrode, and a separator interposed therebetween are wound in one direction based on a winding axis, a battery can accommodating the electrode assembly and including a metal plated layer, and a connection lead plate joining the battery can and the electrode assembly, which includes:
(A) applying a resin for the corrosion prevention layer to a portion where the metal plated layer is damaged at a welding portion formed by melting the connection lead plate and the battery can upon welding of an external bottom surface of the battery can; and
(B) forming the corrosion prevention layer by curing the resin for the corrosion prevention layer by ultraviolet rays,

in which the resin for the corrosion prevention layer includes one or more liquid materials, and

the one or more liquid materials are ultraviolet curable, and have a viscosity of 1 cP to 5000 cP.

According to one aspect of the present invention, provided is a cylindrical secondary battery including: a jelly-roll type electrode assembly having a structure in which a first electrode, a second electrode, and a separator interposed therebetween are wound in one direction based on a winding axis;

a battery can accommodating the electrode assembly and including a metal plated layer;

a connection lead plate joining the battery can and the electrode assembly; and

a corrosion prevention layer manufactured by the manufacturing method of a corrosion prevention layer.

According to one aspect of the present invention, provided is a cylindrical secondary battery including: a jelly-roll type electrode assembly having a structure in which a first electrode, a second electrode, and a separator interposed therebetween are wound in one direction based on a winding axis;

a battery can accommodating the electrode assembly and including a metal plated layer;

a connection lead plate joining the battery can and the electrode assembly; and

a corrosion prevention layer in which the corrosion prevention layer is disposed at a portion where an external surface of the battery can damaged at a welding portion formed by melting the connection lead plate of an external bottom surface of the battery can, and the battery can.

### Advantageous Effects

A manufacturing method of a corrosion prevention layer and a cylindrical secondary battery according to one aspect of the present invention prevent corrosion of a battery can due to a damaged portion of a metal plated layer generated by welding on the battery can, thereby preventing a defect of a product.

In the manufacturing method of a corrosion prevention layer according to one aspect of the present invention, since a resin for the corrosion prevention layer is easily cured by ultraviolet rays, a process is convenient. Further, after the resin for the corrosion prevention layer is applied, the metal plated layer which exists on an exterior of the battery can is prevented from being exposed to a corrosion factor such as air, moisture, etc., and as a result, the corrosion of the battery can be prevented and safety of a battery can be enhanced.

A manufacturing method of a corrosion prevention layer and a cylindrical secondary battery according to one aspect of the present invention can provide an advantage in that the cylindrical secondary battery is not transformed under an activation process (in general, neglected for approximately 24 hours under a high-temperature high-humidity condition (a temperature of approximately 65° C. or more and a humidity of approximately 90% or more).

However, the effects which can be obtained through the present invention are not limited only to the above-described effects, and other technical effects not mentioned herein will be able to be clearly understood from the description of the invention to be described later by those skilled in the art.

### DESCRIPTION OF DRAWINGS

FIGS. 1 and 2 are schematic views illustrating one implementation example of the present invention.

### BEST MODE FOR THE INVENTION

The present invention may have various modifications and various embodiments or embodiments and specific embodiments or implementation examples will be illustrated in the drawings and described in detail in the detailed description. However, this does not limit the present invention to specific embodiments, and it should be understood that the present disclosure covers all the modifications, equivalents and replacements included within the technical spirit and technical scope of the present invention.

In the present specification, terms including as first, second, A, B, and the like are used for describing various constituent elements, but the constituent elements are not limited by the terms. The terms are used only to discriminate one element from another element. For example, a first component may be referred to as a second component, and similarly, the second component may be referred to as the first component without departing from the scope of the present invention.

In the present specification, a term “and/or” includes a combination of a plurality of related items or some of the plurality of related items.

In the present specification, when a certain component is expressed as a singular number, the certain component may include a plurality of concepts even though it is not separately specified in the present specification.

In the present specification, in respect to terms such as “include”, “have”, etc., unless separately specified in the present specification, a feature, a number, a step, an operation, a process, a component, a member, etc., or a combination thereof mean an existence itself, and does not mean excluding another feature, another number, etc.

In the present specification, a term ‘battery can’ may have an opening portion, a cylindrical side portion, and a bottom portion (or bottom surface), and may be generally made of a metallic or alloy material. Preferably, the battery can may be constituted by nickel plated iron (a battery can including a nickel contained metal plated layer and iron).

Further, the ‘battery can’ is an object accommodating an electrode assembly of a secondary battery. The battery can may be cylindrical, and in respect to a size of the battery can, circular diameter of both end portions may be 30 to 55 mm and a height may be 60 to 120 mm. For example, the circular diameter×the height of the cylindrical battery can may be 40 mm×60 mm, 40 mm×80 mm, or 40 mm×90 mm, or 40 mm×120 mm.

In the present specification, the term ‘secondary battery’ refers to a battery which is repeatedly usable for along time through recharging. The secondary battery may be categorized into a nickel-cadmium secondary battery, a lithium ion secondary battery, etc., according to an electrode active material.

In the present specification, the term ‘cylindrical secondary battery’ refers to a secondary battery having a cylinder shape or a type similar thereto. The cylindrical secondary battery which is generally used for large-capacity electronic and electric devices due to a characteristic in which energy density per volume is high may be used in a form in which a plurality of cylindrical secondary batteries are combined to constitute a battery pack. For example, the cylindrical secondary battery may have a structure in which a rivet penetrated and inserted into a bottom portion opposite to the opening portion is used as a cathode and a battery can itself is used as an anode.

In the present specification, a term ‘first electrode’ is a cathode and a term ‘second electrode’ is an anode, but vice versa.

In the present specification, the term ‘cathode’ includes a cathode current collector and a cathode active material applied onto at least one surface of the cathode current collector. An example of the cathode current collector may be aluminum or alloy, but is not limited thereto. An example of the cathode active material may be a lithium contained transition metal oxide, but is not limited thereto.

In the present specification, the term ‘anode’ includes an anode current collector and an anode active material applied onto at least one surface of the anode current collector. An example of the anode current collector may be copper or alloy, but is not limited thereto. An example of the anode active material may be a carbon material, but is not limited thereto.

In the present specification, a term ‘separator’ as a film interposed between the cathode and the anode serves to facilitate movement of ions required for breaking a circuit while separating the cathode and the anode. An example of the separator may be a fine porous film constituted by a polyolefin based film, but is not limited thereto.

In the present specification, a term ‘liquid material’ means a material which maintains a liquid state at room temperature (approximately 25° C.).

In the present specification, a term ‘ultraviolet curability’ means a property of being cured by ultraviolet rays, and for example, when any material is ‘ultraviolet curable’, the case refers to any material being hardened and cured by the ultraviolet rays.

In the present specification, a term ‘metal plated layer’ means a layer applied onto an external surface of the battery can, and this includes a metal plating material. For example, the metal plated layer may be a nickel plated layer.

In the present specification, a term ‘damaged portion’ means a region where an exterior (including even the metal plated layer when the metal plated layer is applied) of the battery can is damaged by a welding process. The welding process is generally performed on an exterior of a bottom of the battery can. However, the metal plated layer may be damaged by the welding process. As a result, the metal plated layer is easily exposed to a corrosion environment such as air, moisture, etc., and as a result, an electrolyte may be leaked.

If it is not contrarily defined, all terms used herein including technological or scientific terms have the same meanings as those generally understood by a person with ordinary skill in the art.

Hereinafter, a preferred embodiment of the present invention will be described in detail with reference to the accompanying drawings.

According to one implementation example of the present invention, provided is a manufacturing method of a corrosion prevention layer of a cylindrical secondary battery including a jelly-roll type electrode assembly having a structure in which a first electrode, a second electrode, and a separator interposed therebetween are wound in one direction based on a winding axis, a battery can accommodating the electrode assembly and including a metal plated layer, and a connection lead plate joining the battery can and the electrode assembly, which includes:
(A) applying a resin for the corrosion prevention layer to a portion where the metal plated layer is damaged at a welding portion formed by melting the connection lead plate and the battery can upon welding of an external bottom surface of the battery can; and
(B) forming the corrosion prevention layer by curing the resin for the corrosion prevention layer by ultraviolet rays, in which the resin for the corrosion prevention layer includes one or more liquid materials, and the one or more liquid materials are ultraviolet curable, and have a viscosity of 1 cP to 5000 cP.

For example, the resin for the corrosion prevention layer may have a viscosity of 1 cP or more, 200 cP or more, 400 cP or more, 600 cP or more, 800 cP or more, 1000 cP or more, 1200 cP or more, 1400 cP or more, 1600 cP or more, 1800 cP or more, 2000 cP or more, 2200 cP or more, or 2400 cP or more.

Further, the resin for the corrosion prevention layer may have a viscosity of 5000 cP or less, 4800 cP or less, 4600 cP or less, 4400 cP or less, 4200 cP or less, 4000 cP or less, 3800 cP or less, 3600 cP or less, 3400 cP or less, 3200 cP or less, 3000 cP or less, 2800 cP or less, or 2600 cP or less.

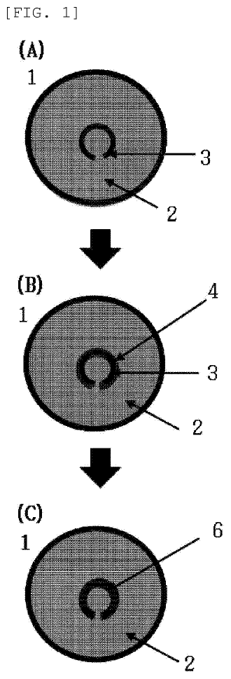

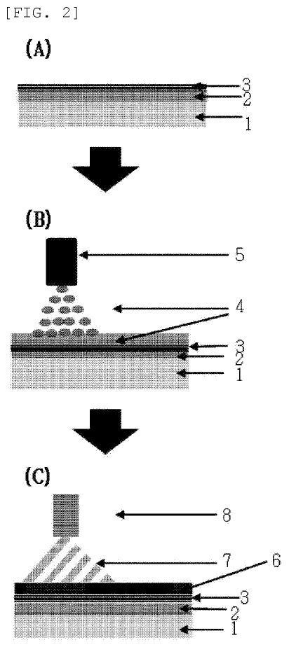

In regard to the implementation example, referring to FIG. 1 and/or FIG. 2, it is illustrated that a corrosion prevention layer resin 4 is cured by ultraviolet rays 7 to form a corrosion prevention layer 6.

In regard to the implementation example, referring to FIG. 2(B), the corrosion prevention layer resin 4 is sprayed and applied onto the battery can 1, and referring to FIG. 2(C), a process of forming a form in which the corrosion prevention layer resin 4 is cured, i.e., the corrosion prevention layer 6 by irradiating the ultraviolet rays 7 is illustrated. A spray method depends on a general method.

The corrosion prevention layer resin used in the implementation example interrupts a corrosion factor such as air or moisture contact with the damaged portion of the battery can to prevent the corrosion. As the corrosion prevention layer resin, a corrosion prevention layer resin is used, which is characterized to have ultraviolet curability and low viscosity. The corrosion prevention layer made of the resin may be formed to have a uniform thickness, and may prevent air bubbles which are generated on the corrosion prevention layer and provide an excellent physical property in terms of heat resistance, thermal conductivity, etc. Further, the corrosion prevention layer made of the corrosion prevention layer resin is not transformed by the activation process (in general, neglected for approximately 24 hours under the high-temperature high-humidity condition (the temperature of approximately 65° C. or more and the humidity of approximately 90% or more)).

An application method of the corrosion prevention layer resin may be performed by an appropriate method in this technical field. The spraying may be performed through equipment such as a nozzle 5, and a discharge amount and a discharge pressure applied to the nozzle may be selected as appropriate ranges in the technical field. The irradiation of the ultraviolet rays 7 may be performed by equipment such as a UV lamp 8, and a wavelength of light applied to a light source of the UV lamp may be selected as an appropriate range in the technical field.

Since the manufacturing method of the corrosion prevention layer according to the implementation example uses one or more ultraviolet curable liquid materials in the corrosion prevention layer resin, the manufacturing method provides convenience of the process. Further, since one or more liquid materials having a low viscosity of 1 cP to 5000 cP are used, the corrosion prevention layer made of the corrosion prevention layer resin may be formed to have a uniform thickness, and may prevent air bubbles which are generated on the corrosion prevention layer and provide an excellent physical property in terms of heat resistance, thermal conductivity, etc. Further, the corrosion prevention layer formed by the manufacturing method by interrupts a corrosion factor such s air or moisture contact with the metal plated layer to prevent the corrosion of the battery can. Further, the corrosion prevention layer made of the corrosion prevention layer resin according to the implementation example is not transformed by the subsequent activation process (in general, neglected for approximately 24 hours under the high-temperature high-humidity condition (the temperature of approximately 65° C. or more and the humidity of approximately 90% or more)).

In particular, it is possible to resolve a problem in that a coating layer formed by a conventional inkjet printing method is taken off and the corrosion occurs.

According to an additional implementation example of the present invention, provided is the manufacturing method of the corrosion prevention layer, in which the corrosion prevention layer resin further includes a light emitting material and which further includes

(C) checking an application state of the corrosion prevention layer resin on the battery can by the ultraviolet rays.

In the manufacturing method according to the implementation example, corrosion prevention may be more efficiently achieved by checking the application state of the corrosion prevention layer resin on a portion where an external surface of the battery can is damaged with the light emitting material in the corrosion prevention layer resin.

As necessary, when a pressure is raised due to gas which exists inside the cylindrical secondary battery, a cleavage valve may be provided in the battery can in order to discharge internal gas to the outside. In this case, a step of forming the corrosion prevention layer by avoiding the cleavage valve may be further included.

In an additional implementation example, provided is the manufacturing method of the corrosion prevention layer, in which the corrosion prevention layer resin includes at least one selected from epoxy based, acrylate-based, silicon-based, and urethane-acrylate-based resins.

In regard to the implementation example, referring to FIG. 2(B), the corrosion prevention layer resin 4 including at least one selected from the epoxy based, acrylate-based, silicon-based, and urethane-acrylate-based resins is sprayed and applied onto the battery can 1, and referring to FIG. 2(C), a process of forming a form in which the corrosion prevention layer resin 4 is cured, i.e., the corrosion prevention layer 6 by irradiating the ultraviolet rays 7 is illustrated.

In the manufacturing method of the corrosion prevention layer according to the implementation example, since the corrosion prevention layer resin includes at least one selected from the epoxy based, acrylate-based, silicon-based, and urethane-acrylate-based resins having ultraviolet curability and low viscosity characteristics, the process may be convenient upon forming the corrosion prevention layer and a thickness of the corrosion prevention layer may be formed to be uniform, and air bubbles generated on the corrosion prevention layer may be prevented and the excellent physical property may be provided in terms of the heat resistance, the thermal conductivity, etc.

According to an additional implementation example of the present invention, provided is the manufacturing method of the corrosion prevention layer in which a curing time in step (B) is 5 seconds or more and 30 seconds or less.

Preferably, the curing time may be 5 second or more, 10 seconds or more, or 15 seconds or more.

Preferably, the curing time may be 30 seconds or less, 25 seconds or less, or 20 seconds or less.

In regard to the implementation example, referring to FIG. 2(B), the corrosion prevention layer resin 4 is sprayed and applied onto the battery can 1. Further, referring to FIG. 2(C), a process is illustrated, in which the corrosion prevention layer resin 4 is cured by irradiating the ultraviolet rays 7 for 5 seconds or more and 30 seconds or less to form a corrosion prevention layer 6.

In the manufacturing method of the corrosion prevention layer according to the implementation example, due to a curing time of a short-term of 5 seconds or more and 30 seconds or less, quickness of the process may be provided and a secondary battery satisfying the range may secure the safety.

According to an additional implementation example, provided is the manufacturing method of the corrosion prevention layer in which the battery can includes iron.

According to an additional implementation example, provided is the manufacturing method of the corrosion prevention layer in which the metal plated layer includes nickel.

The manufacturing method according to the implementation examples may primarily prevent the corrosion of the battery can by providing the metal plated layer (or including the nickel). However, when the bottom surface of the battery can is welded from the outside, the surface of the battery can may be exposed while the metal plated layer is also melted. However, in the case of the implementation example, after the battery can including the metal plated layer is welded, the corrosion prevention layer is disposed at the damaged portion by the welding to prevent the surface of the battery can from being exposed.

According to an additional implementation example, provided is the manufacturing method of the corrosion prevention layer in which the thickness of the corrosion prevention layer is more than 1 μm and less than 10 μm.

Preferably, the thickness of the corrosion prevention layer may be more than 1 μm, more than 2 μm, more than 3 μm, more than 4 μm, or more than 5 μm.

Preferably, the thickness of the corrosion prevention layer may be less than 10 μm, less than 9 μm, less than 8 μm, less than 7 μm, or less than 6 μm.

When a range of the thickness according to the implementation example is satisfied, optimization for a cell size range of the secondary battery is enabled.

According to an additional implementation example, provided is the corrosion prevention layer manufactured according to the manufacturing method of any one of the implementation examples.

In regard to the implementation example, referring to FIG. 1 or 2, the corrosion prevention layer 6 is formed by curing the corrosion prevention layer resin provided to a welding portion 3 positioned on the metal plated layer 2 applied to the battery can 1 by the ultraviolet rays 7.

The corrosion prevention layer according to the implementation example interrupts a corrosion factor such as air or moisture contact with the metal plated layer to prevent the corrosion of the battery can. Since the corrosion prevention layer resin uses one or more liquid materials having the ultraviolet curability and the low viscosity, the corrosion prevention layer formed by using the liquid material may have the uniform thickness, have an air bubble which is not almost generated, and have the excellent physical property in terms of the heat resistance, the thermal conductivity, etc. Further, the corrosion prevention layer is not transformed by the activation process (in general, neglected for approximately 24 hours under the high-temperature high-humidity condition (the temperature of approximately 65° C. or more and the humidity of approximately 90% or more)).

Further, the corrosion prevention layer may also resolve the problem in that the coating layer formed by the conventional inkjet printing method is taken off and the corrosion occurs.

According to one implementation example of the present invention, provided is a cylindrical secondary battery including: a jelly-roll type electrode assembly having a structure in which a first electrode, a second electrode, and a separator interposed therebetween are wound in one direction based on a winding axis;

a battery can accommodating the electrode assembly and including a metal plated layer;

a connection lead plate joining the battery can and the electrode assembly; and

a corrosion prevention layer manufactured by any one of the manufacturing methods of the corrosion prevention layer.

Alternatively, according to one implementation example of the present invention, provided is a cylindrical secondary battery including: a jelly-roll type electrode assembly having a structure in which a first electrode, a second electrode, and a separator interposed therebetween are wound in one direction based on a winding axis;

a battery can accommodating the electrode assembly and including a metal plated layer;

a connection lead plate joining the battery can and the electrode assembly; and

a corrosion prevention layer disposed at a portion where an external surface of the battery can damaged at a welding portion formed by melting the connection lead plate of an external bottom surface of the battery can, and the battery can.

In regard to the implementation examples, referring to FIG. 1(C) or FIG. 2(C), an electrode assembly (not illustrated) having a structure in which the first electrode, the separator, and the second electrode are sequentially stacked and wound, and the corrosion prevention layer 6 positioned on the welding portion 3 positioned on the metal plated layer 2 applied to the external bottom surface 1 of the battery can are illustrated.

The secondary battery according to the implementation example includes a corrosion prevention layer that prevents the corrosion of the battery can by interrupting a corrosion factor such as air or moisture contact with the metal plated layer, and includes a corrosion prevention layer having a uniform thickness, and having an air bubble which is not almost generated and provides an excellent physical property in terms of heat resistance, thermal conductivity, etc. Further, the secondary battery includes a corrosion prevention layer which is not transformed by the activation process (in general, neglected for approximately 24 hours under the high-temperature high-humidity condition (the temperature of approximately 65° C. or more and the humidity of approximately 90% or more)). Accordingly, the cylindrical secondary battery including the corrosion prevention layer has stability and/or safety. Further, when the cylindrical secondary battery includes the corrosion prevention layer, a defective rate of the cylindrical secondary battery may be minimized.

As necessary, when a pressure is raised due to gas which exists inside the cylindrical secondary battery, a cleavage valve may be provided in the battery can in order to discharge internal gas to the outside. In this case, the corrosion prevention layer may be formed by avoiding the cleavage valve.

According to an additional implementation example, provided is the cylindrical secondary battery in which the corrosion prevention layer includes a corrosion prevention layer resin, and the corrosion prevention layer resin is at least one selected from epoxy-based, acrylate-based, silicon-based, and urethane-acrylate-based resins.

In regard to the implementation example, referring to FIG. 2(B), it is illustrated that a corrosion prevention layer resin 4 including at least one selected from the epoxy-based, acrylate-based, silicon-based, and urethane-acrylate-based resins is sprayed and applied to the battery can 1.

In the cylindrical secondary battery according to the implementation example, since the corrosion prevention layer resin includes at least one selected from the epoxy based, acrylate-based, silicon based, and urethane-acrylate-based resins having ultraviolet curability and low viscosity characteristics, the process may be convenient upon forming the corrosion prevention layer and a thickness of the corrosion prevention layer may be formed to be uniform, and air bubbles generated on the corrosion prevention layer may be prevented and the excellent physical property may be provided in terms of the heat resistance, the thermal conductivity, etc.

According to an additional implementation example, provided is the cylindrical secondary battery in which the corrosion prevention layer resin further includes a light emitting material.

In the cylindrical secondary battery according to the implementation example, corrosion prevention may be more efficiently achieved by checking the application state of the corrosion prevention layer resin on a portion where an external surface of the battery can is damaged with the light emitting material in the corrosion prevention layer resin.

According to an additional implementation example, provided is cylindrical secondary battery in which the battery can includes iron.

According to an additional implementation example, provided is cylindrical secondary battery in which the metal plated layer includes nickel.

The cylindrical secondary battery according to the implementation examples may primarily prevent the corrosion of the battery can including the iron by providing the metal plated layer (or including the nickel). However, when the bottom surface of the battery can is welded from the outside, the surface of the battery can may be exposed while the metal plated layer is also melted. However, in the case of the implementation example, after the battery can including the metal plated layer is welded, the corrosion prevention layer is disposed at the damaged portion by the welding to prevent the surface of the battery can from being exposed.

According to an additional implementation example, provided is the cylindrical secondary battery in which the thickness of the corrosion prevention layer is more than 1 μm and less than 10 μm.

Preferably, the thickness of the corrosion prevention layer may be more than 1 μm, more than 2 μm, more than 3 μm, more than 4 μm, or more than 5 μm.

Preferably, the thickness of the corrosion prevention layer may be less than 10 μm, less than 9 μm, less than 8 μm, less than 7 μm, or less than 6 μm.

When a range of the thickness according to the implementation example is satisfied, optimization for a cell size range of the secondary battery is enabled. Although the preferred implementation example of the present invention are described through the above description, but the present invention is not limited thereto and various medications can be made within the claims and the range the detailed description of the invention, and this also belongs to the scope of the present invention.

### EXPLANATION OF REFERENCE NUMERALS AND SYMBOLS

1: Battery can
2: Metal plated layer
3: Welding portion
4: Corrosion prevention layer resin
5: Nozzle
6: Corrosion prevention layer
7: Ultraviolet rays
8: UV lamp

1. A manufacturing method for providing a corrosion prevention layer on a cylindrical secondary battery including a jelly-roll type electrode assembly having a structure in which a first electrode, a second electrode, and a separator interposed therebetween are wound in one direction based on a winding axis, a battery can accommodating the electrode assembly, the battery can including a metal plated layer, and a connection lead plate joining the battery can and the electrode assembly, the method comprising:
applying a resin to a portion where the metal plated layer is welded to the connection lead plate; and
forming the corrosion prevention layer by curing the resin using ultraviolet rays,
wherein the resin includes one or more liquid materials,
wherein the one or more liquid materials are ultraviolet curable, and
wherein the one or more liquid materials have a viscosity of 1 cP to 5000 cP.

2. The method of claim 1,
wherein the resin further includes a light emitting material, and
the method further includes checking an application state of the resin on the battery can by ultraviolet rays.

3. The method of claim 1, wherein the resin is at least one of an epoxy-based, an acrylate-based, a silicon-based, or a urethane-acrylate-based resin.

4. The method of claim 1, wherein a curing time in forming the corrosion prevention layer is 5 seconds or more and 30 seconds or less.

5. The method of claim 1, wherein the battery can includes iron.

6. The method of claim 1, wherein the metal plated layer includes nickel.

7. The method of claim 1, wherein a thickness of the corrosion prevention layer is more than 1 μm and less than 10 μm.

8. A cylindrical secondary battery comprising:
a jelly-roll type electrode assembly having a structure in which a first electrode, a second electrode, and a separator interposed therebetween are wound in one direction based on a winding axis;
a battery can accommodating the electrode assembly, the battery can including a metal plated layer;
a connection lead plate joining the battery can and the electrode assembly; and
a corrosion prevention layer manufactured by the method of claim 1.

9. A cylindrical secondary battery comprising:
a jelly-roll type electrode assembly having a structure in which a first electrode, a second electrode, and a separator interposed therebetween are wound in one direction based on a winding axis;
a battery can accommodating the electrode assembly, the battery can including a metal plated layer;
a connection lead plate joining the battery can and the electrode assembly; and
a corrosion prevention layer disposed at a portion where an external surface of the battery can is welded to the connection lead plate at an external bottom surface of the battery can.

10. The cylindrical secondary battery of claim 8, wherein the corrosion prevention layer includes a resin, and
wherein the resin is at least one of an epoxy-based, an acrylate-based, a silicon-based, or a urethane-acrylate-based resin.

11. The cylindrical secondary battery of claim 10, wherein the resin further includes a light emitting material.

12. The cylindrical secondary battery of claim 8, wherein the battery can includes iron.

13. The cylindrical secondary battery of claim 8, wherein the metal plated layer includes nickel.

14. The cylindrical secondary battery of claim 8, wherein a thickness of the corrosion prevention layer is more than 1 μm and less than 10 μm.
